(19) United States
(12) Patent Application Publication
(10) Pub. No.: US 2014/0006283 A1
(43) Pub. Date: Jan. 2, 2014

(54) SYSTEMS AND METHODS FOR MANAGING MULTIPLE IDENTIFIERS

(71) Applicant: SERVE VIRTUAL ENTERPRISES, INC., St. Petersburg, FL (US)

(72) Inventors: Jason J. Hogg, St. Petersburg, FL (US); Dave Cautin, St. Petersburg, FL (US); Kiran Jagannath, Bangalore (IN); Bob Kerner, St. Petersburg, FL (US); Corey Moreira, St. Petersburg, FL (US); Andrew Peret, St. Petersburg, FL (US); France Roy, St. Petersburg, FL (US)

(73) Assignee: SERVE VIRTUAL ENTERPRISES, INC., St. Petersburg, FL (US)

(21) Appl. No.: 13/653,038

(22) Filed: Oct. 16, 2012

Related U.S. Application Data
(63) Continuation-in-part of application No. 13/540,216, filed on Jul. 2, 2012.

(51) Int. Cl. G06Q 20/40; G06Q 20/10

(52) U.S. Cl. 705/44; 705/39

(57) ABSTRACT

The disclosure includes comprehensive system and methods for enabling value transfer to users of a social networking service. Integration with a social networking service may include use of an app that is capable of accessing social networking profile and contact information and sharing the data with a value transfer service. The app is capable of accessing the social networking service's notification function and sending a notification to a value recipient.

### CROSS-REFERENCE TO RELATED APPLICATIONS

This disclosure is a continuation-in-part of, and claims priority to, U.S. Ser. No. 13/540,216 filed on Jul. 2, 2012 and entitled “Systems and Methods for Transferring Value via a Social Network,” which is hereby incorporated by reference in its entirety.

### FIELD

The present disclosure generally relates to enabling transfer of value via a social network.

### BACKGROUND

Social networking services are greatly increasing with the most popular services (e.g. Facebook) boasting hundreds of millions of registered users. Users of social networking sites often associate with other members of the service, and the service thus stores a huge amount of information not only about a particular user, but other users associated with the user (e.g. the user's “friends,” “connections,” “followers,” etc.). “Apps” (both web and smart phone enabled software applications) are accessible to social networking service users and many such apps allow the users to interact with other users of the social networking site. Furthermore, stored value services and monetary transfer services exist that allow users to transfer value (e.g., typically money) from one user to another. However, such stored value services require information regarding the intended recipient in order to complete a transfer of value from a value sender to a value recipient.

As such, a long felt need exists for an integrated, end-to-end, automated system that enables a first social networking user to seamlessly transfer value to a second social networking user, even if the second user is not registered with the money transfer service from which the first user initiates the transfer.

### SUMMARY

Methods and systems enable a user of a social network service to send value (e.g. money) to another user. In various embodiments, a value transfer computer receives from an app, a value transfer request to transfer a value to a value recipient. The value recipient may not be a registered user of a value transfer service associated with the value transfer computer. The app may be associated with a social networking service and/or the value transfer computer. The app may access, via the social networking service, profile information for the value sender. The app identifies a list of social network users associated with the value sender. For instance, the app may be a Facebook application that accesses the “friends” of the value sender. In various embodiments, the value sender identifies, via the app, the value recipient from the list of social network users.

The value sender may further enter, or otherwise specify, a value to be sent to the value recipient. The app causes a notification to be sent by the social network computer to the value recipient. For example, a Facebook app may post a message on the value recipient's Facebook “wall.” In response to the value recipient accessing the notification, the value transfer computer may receive a registration request to register the value recipient with the value transfer service. The value transfer computer registers the value recipient and, in response to the registering, the value transfer computer transfers the value to the value recipient.

In various embodiments, the value transfer request may comprise a value recipient identifier and the value recipient identifier may be a social network identifier. The social network identifier may be obtained by the app from the social network computer.

In various embodiments, the value transfer computer updates a table associated with the value transfer service with the value transfer request, and the value recipient identifier and/or the social network identifier. The value transfer computer may update a pending transactions table based upon the value transfer request.

In various embodiments, the value transfer computer creates a value recipient account associated with the value recipient. The value recipient account may be created, for example, based upon the registration request. The value transfer computer may prompt the value recipient (i.e., user) for registration information and receive input or otherwise obtain the registration information from the value recipient. In various embodiments, the value recipient account may be created in response to receiving and/or based upon the value transfer request.

In various embodiments, the registration information comprises a primary account identifier and the registering comprises associating a primary account identifier with the value recipient. The value transfer computer may associate a social network identifier with the primary account identifier.

In various embodiments, the value transfer computer creates, based upon the registration request, a value recipient account associated with the value recipient and associates a secondary account identifier with a primary account identifier, wherein the secondary account identifier comprises at least one of an email address, a phone number, a social network identifier, a child account number, a bank account identifier, a transaction account identifier and a rewards account identifier. The various account identifiers may be associated, for example, using a cross-reference table.

In various embodiments, the value transfer computer searches a pending transaction table to identify transactions associated with a value recipient (e.g. a newly registered value recipient). Such searching may be performed in response to a database trigger initiated in response to registration information being inserted or updated in a registration table of a database.

In various embodiments, the value transfer computer associates a pending transaction with the value recipient, wherein the pending transaction is based upon the value transfer request. The value recipient may be presented with the pending transaction and the value transfer computer prompts the value recipient to at least one of approve, decline or modify the pending transaction.

In various embodiments, the value that is the subject of the value transfer may include one or more of a monetary value, a virtual currency, a virtual good, a virtual service and reward points.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram illustrating major system components of a value transfer system, in accordance with various embodiments; and

FIG. 2 is a flow chart illustrating an exemplary process for sending money to a user of a third party service, in accordance with various embodiments.

### DETAILED DESCRIPTION

The systems and methods provide an improved, automated, integrated, online system for transferring value to a member of a third party service (e.g., a friend in a social network). Various embodiments of the social network value transfer system (“SNVTS”) may be implemented by a system, computer readable medium, internet based system, a method or any combination thereof. The systems and methods include a unique combination of one or more features associated with a value transfer service. In various embodiments, a value transfer service may have an app that is registered with and/or executed by any service that allows communication, such as a social networking service (“VTAPP”). For example, the app may be a Facebook app. In various embodiments, the value transfer service may provide various financial transaction services associated with, for example, storing value and/or transferring value.

In various embodiments, the VTAPP is capable of accessing a social networking user's profile information. The profile information may include a list of other users, such as, for example, social networking users. For instance, a first user or entity (“value sender”) may wish to transfer value (e.g., send money) to a second user or entity (“value recipient”). The value sender may be a user of a value transfer service, but the value sender may not know whether the value recipient is registered with the value transfer service. The value sending may not even know if the value recipient is registered with the value transfer service. The value sender may not be aware of how to identify the value recipient within the value transfer service. Exemplary benefits of the system include providing substantially seamless integration with existing services and/or convenient, reliable and secure transfer, for a wide variety of transactions.

While the embodiments described herein are described in sufficient detail to enable those skilled in the art to practice the disclosure, it should be understood that other embodiments may be realized and that logical and mechanical changes may be made without departing from the spirit and scope of the invention. Thus, the detailed description herein is presented for purposes of illustration only and not of limitation.

“Entity” may include any individual, consumer, consumer, group, business, organization, government entity, transaction account issuer or processor (e.g., credit, charge, etc), merchant, consortium of merchants, consumer, account holder, charitable organization, software, hardware, and/or any other entity. For example a “value sender” is an entity that wishes to send value to a “value recipient” entity.

An “account”, “account number” or “account identifier” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a stored value account, rewards account, charge account, credit account, debit account, prepaid account, telephone card, embossed card, smart card, magnetic stripe card, bar code card, transponder, radio frequency card or an associated account. The system may include or interface with any of the foregoing accounts or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

A “transaction account” may include any account that may be used to facilitate a financial transaction. A financial institution or transaction account issuer includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution, but these participants are not shown.

A “financial processor,” “payment network,” or “payment system” or “transaction account issuer” may include any entity which processes transactions, issues accounts, acquires financial information, settles accounts, conducts dispute resolution regarding accounts, and/or the like.

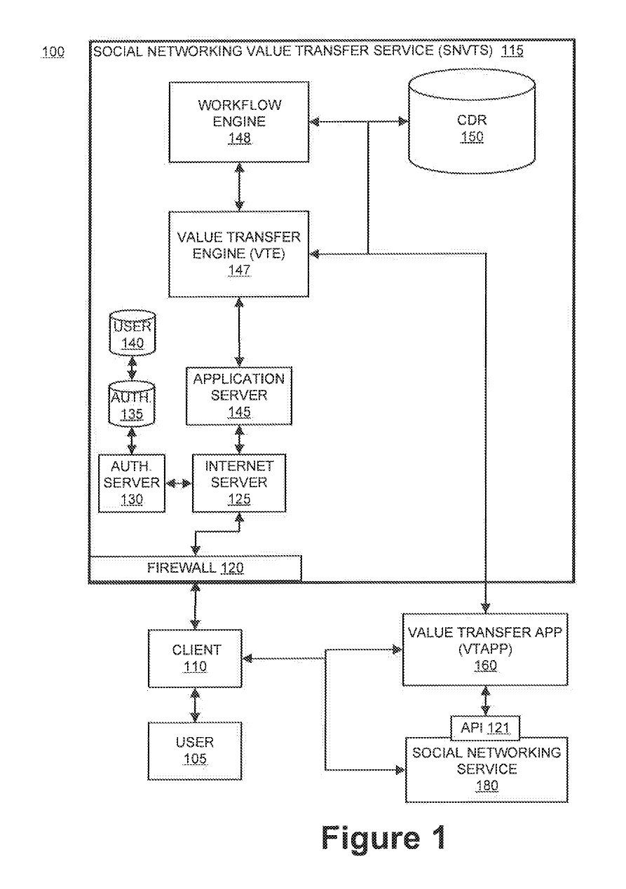

FIG. 1 shows an exemplary block diagram illustrating major system components for enabling SNVTS 115. System 100 facilitates interaction between a user 105 and SNVTS 115 through, in various embodiments, client 110 with a network connection to an Internet server 125 by way of the Internet. In various embodiments, Internet server 125 employs authentication server 130 to validate credentials, assign proper permissions, and retrieve preferences information for authorized user's 105 of SNVTS 115.

In various embodiments, Internet server 125 employs application server 145 to manage various applications and utilities that are utilized by system 100. In various embodiments, application server utilizes APL+Win, JBOSS utilizing SEAM, Richfaces JBPM, and/or other Java libraries (jQuery and Javascript), JAX-WS, Apache POI, and/or Quartz. In various embodiments, Internet server 125 interacts directly with the various systems and components disclosed herein.

SNVTS 115 may include any number of computing platforms and databases such as, for example, vale transfer engine (“VTE”) 147, workflow engine 148 and central data repository (“CDR”) 150. Other systems may include, for example, social networking systems, accounting systems, financial transaction systems, reporting systems, new accounts systems, management information systems, business information systems, external data sources, proprietary systems and the like. Each of the systems may be interconnected within by a network in via any method and/or device described herein. A middleware server and/or application server 145 may serve as an intermediary between the various systems to ensure appropriate communications between disparate platforms. A report engine retrieves and/or is provided with data from certain of the various systems in order to generate notices, bills, messages, audit reports, and the like.

System 100, SNVTS 115 and/or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more of the components of system 100 may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system contemplates uses in association with web services, transaction processing, utility computing, pervasive and individualized computing, security and identity solutions, autonomic computing, commodity computing, mobility and wireless solutions, open source, biometrics, grid computing and/or mesh computing.

User 105 may include any entity that utilizes system 100 or SNVTS 115 functionality. User 105 may include, for example, a user of social networking service 180 that wishes to initiate a transfer and that will be consummated by a value transfer service. In various embodiments, VTAPP 160 accesses social networking service 180 via API 121. In various embodiments, user 105 may interface with SNVTS 115, social networking service 160 and/or VTAPP 160 via any communication protocol, device or method discussed herein or known in the art. For example, user 105 may interact with SNVTS 115 by way of an Internet browser at client 110.

Client 110 comprises any hardware and/or software suitably configured to facilitate requesting, retrieving, updating, analyzing, entering and/or modifying data. For example, in various embodiments, client 110 is configured to facilitate input, receipt, presentations, analysis and/or review of information relating social networking services, value transfer services, etc. Client 110 includes any device (e.g., personal computer) which communicates (in any manner discussed herein) with SNVTS 115, VTAPP 160 and/or social networking service 180 via any network discussed herein. Such browser applications comprise Internet browsing software installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that client 110 may or may not be in direct contact with SNVTS 115 or VTAPP 160. For example, client 110 may access the services of SNVTS 115 through another server, which may have a direct or indirect connection to Internet server 125. Client 110 may access VTAPP 160 via social networking service 180. Client 110 may be mobile or may be located in a home or business environment with access to a network. In an exemplary embodiment, access is through a network or the Internet through a commercially-available web-browser software package.

As those skilled in the art will appreciate, client 110 includes an operating system (e.g., Windows NT, 95/98/2000, OS2, UNIX, Linux, Solaris, MacOS, Android, iPhone OS etc.) as well as various conventional support software and drivers typically associated with computers or computing devices. Client 110 may include any suitable personal computer, mobile device, phone, network computer, workstation, minicomputer, mainframe or the like. Client 110 can be in a home or business environment with access to a network. In an exemplary embodiment, access is through a network or the Internet through a commercially available web-browser software package.

In various embodiments, various components, modules, and/or engines of system 100 may be implemented as micro-applications or micro-apps. In various embodiments, VTAPP 160 is a micro-app that runs on client 110 (e.g. a mobile device). Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

Client 110 may be independently, separately or collectively suitably coupled to the network via data links which includes, for example, a connection to a wireless service provider or an Internet Service Provider (ISP). ISP connections over the local loop is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Client 110 may include any number of applications, code modules, cookies, and the like to facilitate interaction with the various components of System 100 as shown, for example in FIG. 1. Such interaction may include for example, input data, complete templates/forms, view reports, validate data, approve data, review IP asset info, participate in a negotiation, review due diligence documents, respond to a survey, and the like. In various embodiments, client 110 may store user 105 preferences and/or any other information disclosed herein on a hard drive or any other local memory device. Accordingly, client 110 may retrieve and store consumer information within a memory structure of client 110 in the form of a browser cookie, for example. In another embodiment, client 110 retrieves information relating to user 105 from SNVTS 115 on establishing a session with Internet server 125.

Firewall 120, as used herein, may comprise any hardware and/or software suitably configured to protect SNVTS 115 components from users, other networks and systems. Firewall 120 may reside in varying configurations including stateful inspection, proxy based and packet filtering among others. Firewall 120 may be integrated as software within Internet server 125, any other SNVTS 115 components or may reside within another computing device or may take the form of a standalone hardware component. Although depicted as a single firewall in FIG. 1, one skilled in the art will recognize that a firewall or multiple firewalls may be implemented throughout system 100 and/or SNVTS 115 to enable system and data security.

Internet server 125 may include any hardware and/or software suitably configured to facilitate communications between client 110 and one or more SNVTS 115 components. Further, Internet server 125 may be configured to transmit data to client 110 within markup language documents (e.g., XML, HTML, etc.). As used herein, “data” may include encompassing information such as commands, queries, files, data for storage, and/or the like in digital or any other form. Internet server 125 may operate as a single entity in a single physical location or as separate computing components located together or in separate physical locations.

Internet server 125 may provide a suitable web site or other Internet-based graphical user interface which is accessible by consumers. In various embodiments, Internet server 125 employs RedHat Linux Enterprise 5.x Server and Apache Http server. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to markup language based documents (e.g., HTML), various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

In order to control access to components of SNVTS 115, Internet server 125 may invoke authentication server 130 in response to user 105 submissions of authentication credentials received at Internet server 125 from client 110. Authentication server 130 may include any hardware and/or software suitably configured to receive authentication credentials, encrypt and decrypt credentials, authenticate credentials, and grant access rights according to privileges (e.g., pre-defined privileges) attached to the credentials. Authentication server 130 may grant varying degrees of application and data level access to users based on information stored within a database and/or any other known memory structure.

VTE 147 comprises hardware and/or software modules that execute processes, access data from CDR 150 and interact with workflow engine 148 to enable the functionality of SNVTS 115. For example, VTE 147 may receive a request to create a new user in test system 170 and may executed various automated processes to create the new user and to populate data on CDR 150 such that the functionality of VTAPP 160 may be tested using the new user.

Workflow engine 148 comprises hardware and/or software modules that implement process definition, tracking and execution. Workflow engine 148 may comprise one or more software applications, modules or data objects. The software may be any executable code written in any software programming language, such as, for example Java®. For example, workflow engine 148 reads data from CDR 150 and instantiates a data object (e.g. a Java Bean®) to store the data for use by software modules or other objects. In various embodiments, workflow engine 148 executes an automated or partially automated process such as a user account creation process, user creation or deletion process, data population process, etc.

CDR 150 may include any hardware and/or software suitably configured to facilitate storing data relating to, for example, user accounts, user account identifiers, association of user account identifiers, pending transactions, transaction history, account balances, registration, transactions, account settings, user settings, etc.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the system includes special purpose computers, user interfaces (UIs), software modules, logic and/or workflow engines, numerous databases and computer networks. While the system may contemplate upgrades or reconfigurations of existing processing systems, changes to existing databases and system tools are not necessarily required by the system and method.

While the description references specific technologies, hardware, equipment, system architectures and data management techniques, practitioners will appreciate that this description discusses various embodiments and that other devices and/or methods may be implemented without departing from the scope of the disclosure. Similarly, while the description may reference a user interfacing with the system via a personal computer user interface, practitioners will appreciate that other interfaces may include mobile devices, smart phones, tablet computing devices, kiosks and handheld devices such as personal digital assistants.

One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices.

Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Software elements (e.g., modules, engines, etc) may be implemented as a web service. In various embodiments, web services are implemented using Webservice Interoperability Organization Basic Profile 1.1.

Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory (or “computer-readable medium”) that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

System 100 combines unique app, integration, notification and value transfer features to enable a seamless value transfer services. While certain embodiments of the present invention are disclosed herein in terms of integration with a social networking service, practitioners will appreciate that the teachings of the present invention may be equally applicable interchangeably between any type of service or application that enable searching for or otherwise identifying the users of the system or service.

Referring again to FIG. 1, in various embodiments, in response to user 105 logging onto an application, Internet server 125 may invoke an application server 145. Application server 145 invokes logic in VTE 147 by passing parameters relating to the user's 105 requests for data. SNVTS 115 manages requests for data from VTE 147 and communicates with system 101 components. Transmissions between user 105 and Internet server 125 may pass through a firewall 120 to help ensure the integrity of SNVTS 115 components. Practitioners will appreciate that the invention may incorporate any number of security schemes or none at all. In various embodiments, Internet server 125 receives requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of SNVTS 115, Internet server 125 may invoke an authentication server 130 in response to user 105 submissions of authentication credentials received at Internet server 125. In response to a request to access system 100 being received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

SNVTS 115 enables user 105 (e.g., a user of social networking service 180) to configure, register for, transfer value, receive value, fund prepaid accounts, etc. In various embodiments, SNVTS 115 enables the functionality of a transfer received from an app such as VTAPP 160.

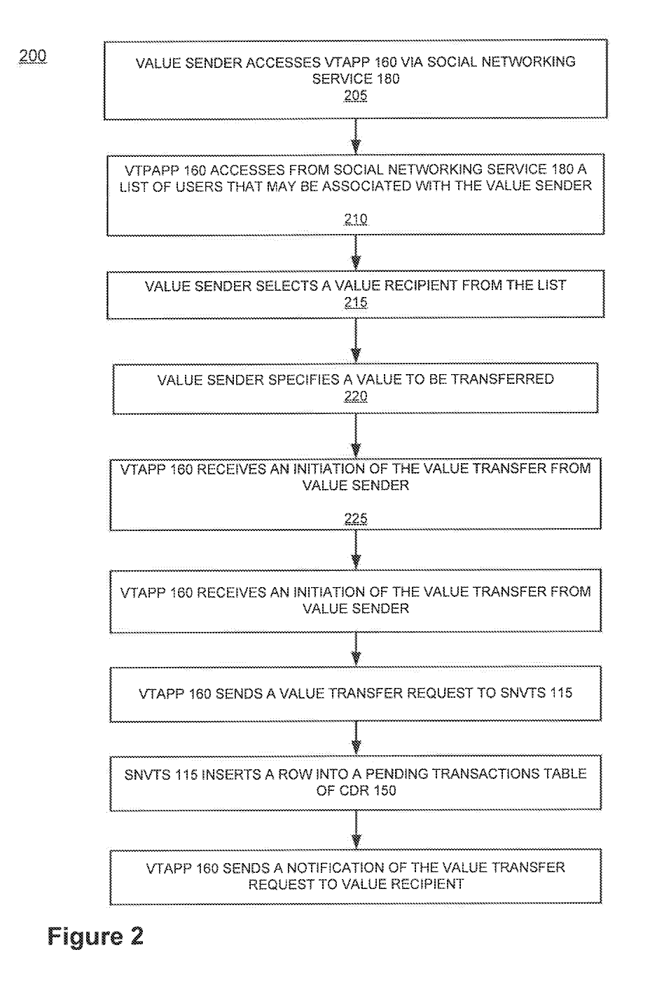

With reference now to FIG. 2, in various embodiments, SNVTS 115 enables a value transfer from a value sender to a value recipient. For example, a value sender may be aware that the value recipient is a user of a social networking service and the value sender may use VTAPP 160 to find the value recipient and initiate a transfer to the value recipient. In various embodiments, the VTAPP 160 may access the profile information of the value recipient's social network account and send a notification to the value recipient based upon the profile information associated with the value recipient's social networking account.

A first user (“value sender”) accesses VTAPP 160 via social networking service 180 (step 205). In various embodiments, VTAPP 160 may communicate with social networking service 180 via various APIs (e.g. API 121). For example, VTAPP 160 may be a value transfer service registered with the Facebook social networking service and accessing Facebook APIs such as the Facebook Graph API. Value sender authorizes VTAPP 160 on the value sender's social networking account and an authentication token is generated by an API. The authentication token enables VTAPP 160 to perform various updates and/or transactions on the user's social networking account (e.g. pull a user's list of friends, post messages to a user's wall or message account on the social network, etc.). For more information on the various Facebook APIs, see https://developers.facebook.com/docs/reference/api, the content of which is hereby incorporated by reference in its entirety.

Value sender may wish to initiate a transfer of value, goods or services to a second user (“value recipient”). VTAPP 160 accesses, from social networking service 180, a list of users that may be associated with the value sender (Step 210). For example, in various embodiments depending on which social networking service 180 is being accessed, this list may include connections on LinkedIn, a list of accounts that a user follows on Twitter, a list of friends in Facebook and/or a user's “circle” information on Google+.

Value sender selects a value recipient from the list (Step 215). In various embodiments, the user may wish to send a similar value to multiple users and VTAPP 160 enables the value sender to select multiple value recipients. As one of skill ion the art will appreciate, sending to multiple users may operate, in various embodiments, in the same fashion as sending to a single recipient, except that various steps are duplicated (e.g., posting notifications) for each recipient.

Value sender specifies a value to be transferred (Step 220). In various embodiments, the value to be transferred may comprise, for example, monetary value, a virtual currency, a virtual good, a virtual service and reward points. An example of a virtual currency may be points, “gold coins” or the like associated with an online game or a game associated with social networking service 180. An example of a virtual good may be an asset in a simulation game such as a tractor in the popular Facebook game “Farmville.”

VTAPP 160 receives an initiation of the value transfer from value sender (Step 225) and sends a value transfer request to SNVTS 115 (Step 230). In various embodiments, in response to receiving the value transfer request, SNVTS 115 inserts a row into a pending transactions table of CDR 150 (Step 235). The inserted row may, for example, include data identifying the value sender, the value recipient, the value transfer amount and/or other information identifying the value transaction (e.g. date, time, initiating system, etc.).

In various embodiments, the value recipient is identified in the value transfer request by a secondary identifier and the secondary identifier is used to identify the value recipient in the row inserted into the pending transactions table. A secondary account identifier may include, for example, one or more of an email address, a phone number, a social network identifier, an account number, a child account number, a bank account identifier, a transaction account identifier and/or a rewards account identifier.

In various embodiments, VTAPP 160 may determine that the value recipient identified in the value transfer request is a registered user of SNVTS 115. VTAPP 160 may query a primary user identifier table, or an account identifier cross-reference table of CDR 150, and search for an existing account corresponding to the identifying information regarding value recipient that VTAPP 160 received from social networking service 180. For example, social networking service 180 may be Facebook and VTAPP 160 may obtain value recipient's Facebook identifier from Facebook via, for example, the processes discussed above. VTAPP 160 may query a secondary account identifier table in CDR 150 to determine whether the Facebook identifier of the value recipient exists in CDR 150 and, if so, VTAPP 160 reads the cross reference information on the secondary account identifier table, determines the primary account identifier for the value recipient and uses the primary account identifier in the row inserted in the pending transactions table. In various embodiments, the pending transactions table stores both the primary identifier and the secondary identifier of the value recipient.

In various embodiments, a primary identifier in SNVTS 115 is determined for the value recipient and SNVTS 115 completes the value transfer transaction; e.g., SNVTS 115 debits the account of the value sender, credits an account of the value recipient, updates a transaction history table and leaves no indication of a pending transaction in CDR 150.

VTAPP 160 sends a notification of the value transfer request to value recipient (Step 240). In various embodiments, VTAPP 160 may invoke an API of social networking service 180 in order to send notification to the value recipient. In various embodiments, VTAPP 160 may send notification via email, text message (e.g. short message service), etc. For example, VTAPP 160 in accessing the list of users associated with the value sender, VTAPP 160 may obtain email addresses, phone numbers, etc. of the value recipient from social networking service 180 and may use such information in sending the notification of the value transfer to the value recipient.

In various embodiments, VTAPP 160 may determine, as disclosed above, that value recipient is a registered user of SNVTS 115 and send a notification of the value transfer to the value recipient via SNVTS 115's messaging module; e.g. an account notifications module that causes a message to be displayed to an SNVTS 115 user on a notifications interface of the system.

The value recipient views the notification of the value transfer and takes action to complete the value transfer. For instance, the value recipient may view a notification of the value transfer on the value recipient's Facebook wall. The notification message may comprise a link or button that, when accessed by the value recipient, directs the user to an application associated with SNVTS 115. In various embodiments, the application that the value recipient is directed to via the notification message may be VTAPP 160 and/or may be a web page interface of SNVTS 115. For purposes of illustration, the following disclosure discusses embodiments where, in response to clicking an object (e.g. a hyperlink) included in the notification message, the value recipient is directed to VTAPP 160.

Value recipient is prompted to register for VTAPP 160. A registration process presents value recipient with an interface and value recipient enters identifying information. In various embodiments, the hyperlink from the notification may have encoded within it, profile information (e.g., social network user identifier, name, etc.) about the value recipient and VTAPP 160 may auto-populate this information in the registration interface.

VTAPP 160 communicates the registration information to SNVTS 115. SNVTS 115 receives the registration information as a registration request. In response to receiving the registration request, SNVTS 115 and/or its various modules (e.g., workflow engine 148) completes the registration process for the value recipient. In various embodiments, SNVTS 115 validates and/or verifies the registration information as part of the registration process. For example, SNVTS 115 may receive a primary account identifier (e.g. email address) and a secondary user identifier (e.g. Facebook ID) as part of the registration request. SNVTS 115 may execute logic to determine whether, for example, the primary user identifier is already present in the primary user identifier table of CDR 150, whether the secondary user identifier received in the registration request is already present in the secondary user identifier table, whether the secondary user identifier is already associated with a different primary account identifier, etc. In various embodiments, any of these conditions may cause an error in the registration process and/or SNVTS 115 may initiate a process to query the user to reconcile and/or correct the registration information.

In various embodiments, completing the registration process includes inserting a row into the primary account identifier table. In various embodiments, SNVTS 115 also inserts a row in the secondary account identifier table and an account identifier cross-reference table. One of skill in the art will recognize that SNVTS 115 may make use of a wide range of database configurations, designs and table definitions, and the database schema discussed herein is disclosed as merely an example of a schema that is used in various embodiments. For example, in various embodiments, the secondary identifier table may contain a cross-reference (e.g. a primary or foreign key relationship) to the primary identifier table. Furthermore, secondary identifiers may be nested into a hierarchy of an unlimited number of sublevels such at there exist secondary, tertiary, fourth-level etc. identifiers which may all relate, directly or indirectly, to a single primary account identifier. In various embodiments, a parent account identifier may be associated with a child account identifier. For example, a parent account may be used as a funding source for a child account or impose restrictions on a child account. For more information regarding parent and child accounts, see U.S. Pat. No. 7,909,246 which issued on Mar. 22, 2011 and entitled System and Method for Establishment of Rules Governing Child Accounts, which is hereby incorporated by reference in its entirety.

In various embodiments, in response to a row being inserted in the primary account identifier table, SNVTS 115 may automatically (e.g. via a database trigger that fires upon the event of a row insertion) initiate a process to determine whether there are any pending transactions for the newly registered user (e.g. the value recipient). In an embodiment, SNVTS 115 identifies the pending transaction record (e.g. the row that was inserted in the pending transaction table by the transfer value request) by matching the secondary account identifier of the (newly registered) value recipient user with the account identifier inserted in the pending transactions table.

In response to matching an account identifier of the value recipient with an account identifier on any of the records (e.g. rows) of the pending transactions table, SNVTS 115 completes the transfer of value from the value sender to the value recipient.

In various transactions, completing the transfer may include debiting a user account of the value sender, crediting a user account of the value receiver, updating the pending transactions table and updating a transaction history, audit or reporting table.

In various embodiments, completing the value transfer may comprise presenting the value recipient with the pending transaction and prompting the value recipient to at least one of approve, decline or modify the pending transaction.

As discussed above, SNVTS 117 may enable transfer of a wide array of value such as, for example, money, international currency, virtual currency, virtual goods, etc. As such, in various embodiments, SNVTS 117 enables multiple value accounts that are identified via a primary account identifier and may be associated with multiple secondary account identifiers. For example, in various embodiments, user value accounts may be set up as “purses” and there may be one “purse” for each type of value that might be transferred (e.g. a virtual currency purse, a Zynga gold coin purse, a Farmville virtual asset purse, a US dollar purse, a Euro purse, a rewards account purse, etc.) In an embodiment, SNVTS 115 enables a marketplace for exchanging or converting value from one type to another (e.g. convert US dollars to rewards points or transfer a tractor in Farmville in exchange for gold coins in Zynga poker).

As previously discussed, SNVTS 115 may be configured to associate multiple account identifiers (“account ID)s”) with an account. In various embodiments, SNVTS 115 receives an add request to add a first account identifier to an account. The add request may be received as part of a registration process associated SNVTS 115 and/or may be received via a third-party service (e.g., a web site, a web service, a social networking service, a gaming service, an application and an app). The first account identifier may be an email address, a phone number, a social network identifier, a child account number, a bank account identifier, a user identifier (“user id”) for a third-party web site, a user id for a third-party application, a user identifier user id for a third party app; a transaction account identifier and a rewards account identifier.

In various embodiments, SNVTS 115 may determine that the first account identifier is unique among a plurality of account identifiers associated with a value transfer service. SVNTS 115 may be configured to allow for duplicate account identifiers (e.g., secondary identifiers may not have to be unique).

SNVTS 115 may determine a primary account identifier of the account. In various embodiments, the primary account identifier is included in the add request. SNVTS 115 associates the primary account identifier with the first account identifier and designates the first account identifier as a secondary account identifier. As discussed previously, a primary account identifier may be associated with one or more secondary account identifiers. Secondary identifiers may be associated with each other and with other level identifiers (e.g., tertiary, fourth-level, etc.).

In various embodiments, SNVTS 115 may receive a request for a value transfer service and the request may include a secondary account identifier (e.g. the “first account identifier” discussed immediately above). SNVTS 115 determines a primary account identifier based upon the secondary account identifier that was included in the request. SNVTS 115 may complete a transaction associated with the value transfer service request using, for example, the primary account identifier and/or the secondary account identifier. In various embodiments, completing the transaction on a third-party service may include completing the transaction using the secondary account identifier where, for example, the secondary account identifier may be the main (or “primary”) means by which an account is identified on the third-party service. A third-party service may include at least one of a web site, a web service, a social networking service, a gaming service, an application, an app, etc. A value transfer service request comprises, for example, one or more of a request to transfer value, receive value and add value.

In various embodiments, SNVTS 115 may validate the first account identifier received in an add request by using, for example, a predetermined rule. In various embodiments, the invalidating includes validating using a third-party service associated with the first account identifier. For example, SNVTS 115 may access the third-party service (e.g. via an API) and execute a user identification validation process of the third-party service using the first account identifier. In various embodiments, SNVTS 115 may prompt a user for at least one of: a password of permission to log-in to the third-party service and a password associated with the first account identifier.

In various embodiments, SNVTS 115 may utilize a first secondary account identifier to determine a second primary account identifier. For example, SNVTS 115 may access a cross-reference table or object model and use a first secondary account identifier to determine the primary account identifier associated with the first secondary account identifier. SNVTS 115 may use the primary account identifier to access all the secondary account identifiers associated with the primary account identifier. In various embodiments, SNVTS 1115 may receive a first secondary account identifier in a value transfer service request, determine a second secondary account identifier, and complete a transaction using the second secondary account identifier.

SNVTS 115 may, in various embodiments, associate a first account identifier received via an add request with a secondary account identifier (which is itself associated with a primary account identifier). SNVTS 115 may designate the first account identifier as a tertiary account identifier.

In various embodiments, SNVTS 115 determines that a first account identifier is unique by determining that the first account identifier is not identical to any other account identifier associated with the value transfer service.

In various embodiments, receiving a value transfer service request includes receiving the value transfer service request from a value sender via a third-party service, wherein the third-party service comprises at least one of a web site, a web service, a social networking service, a gaming service, an application and an app. The third-party service may enable the user to identify a value recipient. For example, the third-party service may accesses a user's (e.g. the “value sender”) profile information and present a list of potential value recipients associated with the value sender. The value sender may identify, via the third-party service, a value recipient from the list of potential value recipients.

In various embodiments, receiving the add request occurs as part of a registration process for a third-party service. For example, as part of a registration process for a gaming service or an e-commerce service, the service may access the value transfer service and associate an account identifier of the third-party service with a primary account identifier of the value transfer service.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

1. A computer-based method comprising:
processing, by an account management computer, an add request to add a first account identifier to an account;
determining, by the computer, a primary account identifier of the account;
associating, by the computer, the primary account identifier with the first account identifier;
designating, by the computer, the first account identifier as a secondary account identifier, wherein the primary account identifier may be associated with one or more secondary account identifiers;
receiving, by the computer, a value transfer service request for a value transfer service, wherein the value transfer service request comprises the first account identifier;
determining, by the computer, the primary account identifier based upon the first account identifier; and
completing, by the computer, a transaction associated with the value transfer service request using at least one of the primary account identifier and the first account identifier.

2. The method of claim 1, wherein the first account identifier comprises at least one of an email address, a phone number, a social network identifier, a child account number, a bank account identifier, a user identifier (“user id”) for a third-party web site, a user id for a third-party application, a user identifier user id for a third party app, a transaction account identifier and a rewards account identifier.

3. The method of claim 1, further comprising validating, based upon a pre-determined rule, the first account identifier.

4. The method of claim 3, wherein the validating comprises validating using a third-party service associated with the first account identifier, wherein the third-party service comprises at least one of a web site, a web service, a social networking service, a gaming service, an application and an app.

5. The method of claim 4, wherein the validating comprises executing a user identification validation process of the third-party service.

6. The method of claim 5, further comprising prompting the user for at least one of: a password of permission to log-in to the third-party service and a password associated with the first account identifier.

7. The method of claim 1, wherein the processing comprises receiving the add request occurs as part of a registration process for a third-party service, wherein the third-party service comprises at least one of a web site, a web service, a social networking service, a gaming service, an application and an app.

8. The method of claim 1, further comprising determining that the first account identifier is unique among a plurality of account identifiers associated with a value transfer service.

9. The method of claim 1, further comprising prompting a user associated with the add request whether the first account identifier should be the primary account identifier for the account.

10. The method of claim 1, wherein the value transfer service request comprises at least one of a request to transfer value, receive value and add value.

11. The method of claim 10, wherein the completing the transaction comprises completing the transaction on a third-party service using the first account identifier, wherein the third party service comprises at least one of a web site, a web service, a social networking service, a gaming service, an application and an app.

12. The method of claim 1, further comprising determining, by the system, the primary account identifier based upon the first account identifier and determining a second account identifier based upon the primary account identifier.

13. The method of claim 12, wherein the completing the transaction comprises completing the transaction using the second account identifier.

14. The method of claim 12, wherein the determining the second account identifier based upon the primary account identifier comprises determining using at least one of an object model and a cross-reference data table.

15. The method of claim 1, wherein the receiving the value transfer service request comprises receiving the value transfer service request from a value sender via a third-party service, wherein the third-party service comprises at least one of a web site, a web service, a social networking service, a gaming service, an application and an app.

16. The method of claim 15, wherein the third-party service accesses value sender profile information and identifies a list of potential value recipients associated with the value sender.

17. The method of claim 16, wherein the value sender identifies, via the third-party service, a value recipient from the list of potential value recipients.

18. The method of claim 1, wherein the associating comprises associating the first account identifier with a secondary account identifier associated with the primary account identifier and designating the first account identifier as a tertiary account identifier, wherein the secondary account identifier may be associated with one or more secondary account identifiers and tertiary account identifiers.

19. A system comprising:
an account management processor;
a tangible, non-transitory memory configured to communicate with the processor, the tangible, non-transitory memory having instructions stored thereon that, in response to execution by the processor, cause the processor to perform operations comprising:
processing, by the processor, an add request to add a first account identifier to an account;
determining, by the processor, a primary account identifier of the account;
associating, by the processor, the primary account identifier with the first account identifier;
designating, by the processor, the first account identifier as a secondary account identifier, wherein the primary account identifier may be associated with one or more secondary account identifiers;
receiving, by the processor, a value transfer service request for a value transfer service, wherein the value transfer service request comprises the first account identifier;
determining, by the processor, the primary account identifier based upon the first account identifier; and
completing, by the processor, a transaction associated with the value transfer service request using at least one of the primary account identifier and the first account identifier.

20. An article of manufacture including a non-transitory, tangible computer readable storage medium having instructions stored thereon that, in response to execution by an account management computer, cause the account management computer perform operations comprising:
processing, by the computer, an add request to add a first account identifier to an account;
determining, by the computer, a primary account identifier of the account;
associating, by the computer, the primary account identifier with the first account identifier;
designating the first account identifier as a secondary account identifier, wherein the primary account identifier may be associated with one or more secondary account identifiers;
receiving, by the computer, a value transfer service request for a value transfer service, wherein the value transfer service request comprises the first account identifier;
determining, by the computer, the primary account identifier based upon the first account identifier; and
completing, by the computer, a transaction associated with the value transfer service request using at least one of the primary account identifier and the first account identifier.
